(19) United States
(12) Patent Application Publication
(10) Pub. No.: US 2024/0392495 A1
(43) Pub. Date: Nov. 28, 2024

(54) A PROCESS FOR DECOLOURING TEXTILES

(71) Applicant: TEXTILE CHANGE APS, Vejle (DK)

(72) Inventors: Ditte Hojland, Vejle (DK); Simon Hundahl Rossen, Galten (DK); Emma Thonesen Hostrup, Aarhus (DK); Emil Rasmussen, Soborg (DK); Anna Tode, Aarhus (DK)

(21) Appl. No.: 18/714,822

(22) PCT Filed: Jan. 16, 2023
(86) PCT No.: PCT/EP2023/050835

§ 371 Date: May 30, 2024

(30) Foreign Application Priority Data
Jan. 28, 2022 (DK) PA 2022 00080

(51) Int. Cl. D06L 4/75; D06L 4/13; D06L 4/15

(52) U.S. Cl. CPC D06L 4/75; D06L 4/13; D06L 4/15; D10B 2201/02; D10B 2201/20; D10B 2331/04; D10B 2331/06; D10B 2331/12

(57) ABSTRACT

A process is shown for providing a solid fraction from a textile product including a natural fiber, a synthetic fiber, or both. The process involves the treatment of the textile product with a water-soluble salt of dithionous acid followed by a treatment of an aprotic solvent, such as dimethyl sulfoxide.

### TECHNICAL FIELD OF THE INVENTION

The present invention relates to a process for decoloring textiles, and for preparing a textile product for recycling.

### BACKGROUND OF THE INVENTION

Around 85% of all textiles thrown away amounts in 2017 to roughly 13 million tons in US alone.

The textile waste is traditionally either dumped into landfill or burned.

Globally, it is estimated that 92 million tons of textile waste are created each year and is equivalent to one rubbish truck filled with clothes ending up on landfill sites every second. By 2030, it is expected that more than 134 million tons of textiles are discarded every year.

Disposal of such large volumes of textile waste is an increasing problem for the apparel industry. The rising costs, reduction in available space, and concern for the environment makes the burning and landfilling of textile waste dwindling options.

Reuse or recycling of the fibres from textiles has been investigated for decades and several methods exists. However, a large percentage of the textile waste comprises blends of fibres such as polyester/cellulosic fabrics, e.g., polyester/cotton and polyester/Tencel™ blends, but also other fibres may be included, such as elastane. The reuse or recycling of the individual blended materials is complicated by the fact that there are inherent differences in the physical properties and composition of the components. Additionally, the fabrics are treated with resinous materials and other finishing compounds, such as dyes. This makes it nearly impossible to find potential commercial end uses for this material other than rags or cloth scraps, which are of little monetary value.

Therefore, there is an interest in the industry for providing potential methods of recycling textile waste comprising blends of fibres, such as polyester/cotton fabric blends, which may be reused e.g., in textiles.

Another challenge of reusing textile waste comprising blends of fibres is the presence of dye in the textile. The decolorization of textile waste (pre- and postconsumer) is a huge issue in textile fibre-to-fibre recycling methods, due to a vast number of different dyes and the need to remove them before the textile waste materials can be dissolved and spun into recycled fibres.

When it comes to dyeing fibres, some fibres adhere to and accept dyes easily, while others do not. Depending on the purpose one is seeking to achieve by dyeing the fabric, and the type of dye one is planning to use, very different processes are needed. The dyes are classified by different classification systems, such as chemical classes (e.g., indigoid dyes and azo dyes, such as mono-, di-, and tri-azo dyes) and dye classes (e.g., disperse dyes, vat dyes, insoluble azo dyes, and reactive dyes).

Reactive dyes are extensively used in the dying of cellulosic fabrics, such as cotton. The reactive dye makes a covalent bond with the polymer fibre, thereby becoming an integral part thereof. The term “reactive” is due to this type of dye being the only type of dye that has a reactive group, which reacts chemically with the polymer fibre molecules to form covalent bonds. The use of reactive dyes is increasing. However, one of the challenges with reactive dyes is the subsequent stripping from the fibres during recycling. Traditionally, it is believed that reactive dye cannot be satisfactorily stripped from the fibre due to the covalent bond between dye molecule and fibre. Since stripping of the dyes including the reactive dyes becomes necessary when textiles are to be reused-a satisfactorily stripping of reactive dyes from the textile fibres is therefore desirable.

Hence, it is desirable to provide a process for recovering the individual solid fractions from a textile product. In particular, a process for recovering solid fractions, which are decoloured, which process is easy, reliable, efficient, environmentally friendly, cheap, and fast would be advantageous.

### SUMMARY OF THE INVENTION

Thus, an object of the present invention is to provide a process for recycling a decolored solid fraction from a colored textile product.

In particular, it is an object of the present invention to provide a process that solves the above-mentioned problems of the prior art with recovering a decolored solid fraction in an easy, reliable, efficient, environmentally friendly, cheap, and fast manner.

This invention makes it possible to decolorize untreated or pre-treated (alkali and/or acid pre-treatments) textile fabrics. Solutions, preferably alkaline, of water-soluble salts of dithionous acid, i.e., sodium and potassium salts of dithionous acid (potassium dithionite and sodium dithionite) was initially tried as decolorizing agents in water with little effect on decolorization of the textile fabric. However, surprisingly, when the dithionous acid salt treated textile fabric was subsequently treated with an aprotic solvent, such as dihydrolevoglucosenone (Cyrene), and dimethyl sulfoxide (DMSO), a positive effect was observed as the textile fibres were markedly decolorized. The same effect was not obtained when the textile fibres were treated with an aprotic solvent alone.

Thus, one aspect of the invention relates to a process for providing at least one solid fraction from a textile product comprising a natural fibre and/or a synthetic fibre, the process comprises the steps of:
(i) providing the textile product comprising a natural fibre and/or one or more synthetic fibres;
(ii) performing a first decolorization step of adding a liquid solution of a first decolorizing agent in water to the textile product; thereby providing a first decolorized textile product;
(iii) separating the first decolorized textile product from a color-fraction;
(iv) performing a second decolorization step of adding a second decolorizing agent comprising an aprotic solvent to the textile product, thereby providing a second decolorized textile product; and
(v) separating the second decolorized textile product from a color-fraction, thereby providing the at least one solid fraction;

wherein the first decolorizing agent in the first decolorization step (ii) is an aqueous solution of a water-soluble salt of dithionous acid.

In one or more embodiments, the first decolorizing agent in the first decolorization step (ii) is a water-soluble salt of dithionous acid provided in an aqueous alkaline solution, such as in a sodium hydroxide solution.

In the present context, the term “solid fraction” is meant to include both a powder fraction and/or a fibrous fraction.

In the present context, the term “color-fractions” refer to either the aqueous solution with soluble dyes and dye residues, or the aprotic solvent solution with soluble dyes and dye residues.

In the present context, the term “synthetic fibre” is meant also to include semi-synthetic fibres.

Yet another aspect of the present invention relates to the use of the solid fractions, in particular the natural fibre, according to the present invention in the preparation of a textile product.

A further aspect of the present invention relates to a textile product comprising the solid fractions, in particular the natural fibre, according to the present invention.

Still another aspect relates to a solid fraction produced by the process according to the present invention.

The present invention will now be described in more detail in the following.

### DETAILED DESCRIPTION OF THE INVENTION

Accordingly, the inventors of the present invention surprisingly found that not only water-soluble dyes, but also water-insoluble dyes may be effectively removed from a textile product. In particular, the process according to the present invention showed to be extremely effective in removing disperse dyes, insoluble azo dyes, vat dyes, and reactive dyes from the textile product.

This invention makes it possible to decolorize untreated or pre-treated (alkali and/or acid pre-treatments) textile fabrics.

Hence, a preferred embodiment of the present invention relates to a process for providing at least one solid fraction from a textile product comprising a natural fibre and/or a synthetic fibre, the process comprises the steps of:
(i) providing the textile product comprising a natural fibre and/or one or more synthetic fibres;
(ii) performing a first decolorization step of adding a liquid solution of a first decolorizing agent in water to the textile product; thereby providing a first decolorized textile product;
(iii) separating the first decolorized textile product from a color-fraction;
(iv) performing a second decolorization step of adding a second decolorizing agent comprising an aprotic solvent to the textile product, thereby providing a second decolorized textile product; and
(v) separating the second decolorized textile product from a color-fraction, thereby providing the at least one solid fraction;

wherein the first decolorizing agent in the first decolorization step (ii) is an aqueous solution of a water-soluble salt of dithionous acid.

Natural fibres may e.g., be produced by plants or algae and may include cellulose and may be provided e.g., as cotton, hemp, sisal, bamboo, viscose, lyocell, or TENCEL™.

Synthetic fibres are synthesized in large amounts compared to the separation of natural fibres, but for clothing natural fibres provides benefits, like comfort and water sorption, over their synthetic counterparts.

Before treating the textile product, the textile product may be shredded to smaller pieces. Preferably the smaller pieces of textile product may be below approximately 10×10 cm, such as below 5×5 cm, e.g., below 1×1 cm.

Water-soluble salts of dithionous acid, such as potassium dithionite and sodium dithionite, are known as reducing agents. However, it may be speculated that they also assist, perhaps in corporation with the water, in chemically cleavage, e.g., hydrolysis, of the reactive dyes in the textile product, or at least assist in weakening the bonds between the reactive dye and the textile, as an aprotic solvent is subsequently capable of dissolving the possibly reduced and cleaved reactive dyes. The water-soluble salts of dithionous acid are preferably provided in an aqueous alkaline solution, such as in a sodium hydroxide solution.

The color-fractions, i.e., either the aqueous solution with soluble dyes and dye residues, or the aprotic solvent solution with soluble dyes and dye residues may be separated from the solid fractions, e.g., by draining, centrifugation, or filtration. The solubilized dyes include reactive dyes, insoluble azo dyes, vat dyes, dispersed dyes, and/or dye residues thereof, but other dyes may also be present.

Reactive dyes may be a class of dyes, which makes covalent bonds with the fibres and becomes a part of the fibres. Reactive dyes are traditionally difficult to remove from textile products. The reactive dye contains a functional group that reacts with the polymers in the textile fibres. Reactive dyes have good fastness properties owing to the covalent bonding that occurs during dyeing. Reactive dyeing is the most important method for the coloration of cellulosic fibres.

Vat dyes is used to describe a chemical class of dyes that are applied to cellulosic fibre (e.g., cotton) using a redox reaction in the process. The most common reducing agent is sodium dithionite (Na₂S₂O₄), which converts the dye to its “leuco” form that is water soluble. Once attached to the fabric fibres, the leuco dye is then oxidized to the insoluble state, which is intensely coloured. One example of such a dye is indigo dye.

Disperse dyes are in general small, planar and non-ionic molecules, with attached polar functional groups like hydroxyalkyl, —NO2 and —CN. Its shape and size make it possible for the dye to slide between the tightly packed polymer chains in the textile fibres, and the polar groups improve water solubility and dipolar bonding between dye and polymer, as well as affecting the hue of the dye. The interactions between dye and polymer are thought to be van der Waals and dipole forces. Disperse dyes are formulated to permit dyeing of hydrophobic thermoplastic fibres including nylon, polyester, acrylic, and other synthetic fibres.

Insoluble azo dyes (water-insoluble azo dyes or direct dyes) are used for dyeing polyester- and cotton-based textiles. An insoluble azo dye is produced directly onto or within a fibre. Diazonium ions are produced when for example an aryl amine is reacted in aqueous solution with a dissolved nitrite of an alkali metal in the presence of hydrochloric acid or alternatively, with an organic nitrite, e.g., t-butylnitrite in an organic solvent. A diazonium ion is a reactive intermediate that is capable of undergoing substitution or coupling reactions. For example, groups like halogen, cyamide, hydroxyl, or hydrogen may substitute for a diazo group bonded to an arene (ArN2+). Compounds such as aniline and phenol, in which strong electron donating groups (e.g., —OH and —NH2) activate the ortho and para positions on a benzene ring, can undergo coupling reactions with a diazonium ion. The mechanism of a coupling reaction is an electrophilic aromatic substitution reaction.

In one or more embodiments, the water-soluble salt of dithionous acid is provided in an aqueous alkaline solution, such as in a sodium hydroxide solution.

In one or more embodiments, the first decolorization step (ii) is performed at a temperature within the range of 30-100 degrees Celsius, such as within the range of 40-95 degrees Celsius, preferably within the range of 50-90 degrees Celsius, e.g., within the range of 55-85 degrees Celsius, more preferably within the range of 70-90 degrees Celsius, e.g., at a temperature of about 85 degrees Celsius.

In one or more embodiments, the textile product is subjected to a pre-treatment step before the first decolorization step (ii), wherein said pre-treatment step comprises one, two, or three steps selected from:
(a) an acidic treatment;
(b) an alkaline treatment;
(c) a hydrogen peroxide treatment;
(d) or a combination of (a), (b) and/or (c).

In one or more embodiments, the textile product is subjected to a pre-treatment step before the second decolorization step (iv), wherein said pre-treatment step comprises one, two, or three steps selected from:
(a) an acidic treatment;
(b) an alkaline treatment;
(c) a hydrogen peroxide treatment;
(d) or a combination of (a), (b) and/or (c).

The pre-treatments of the textile product before steps (ii) and (iv) assist in removing dyes from the textile products. The inventors of the present invention found that the dye of the textile product is not removed during the pre-treatment steps, but the pre-treatments result in an improved release and removal of dye during the subsequent decolorization steps. Furthermore, the pre-treatments aids in removing metals and silicates from the textile product, thereby making it easier to reuse for spinning processes.

When the pre-treatment involves a combination of the acidic pre-treatment (pre-treatment (a)); the alkaline pre-treatment (pre-treatment (b)); and/or the hydrogen peroxide pre-treatment (pre-treatment (c)), the pre-treatment may be performed simultaneously or sequentially. Preferably, the pre-treatments are performed sequentially.

In one or more embodiments, the pre-treatment comprises the combination of (b) an alkaline treatment and (c) a hydrogen peroxide treatment.

In yet an embodiment of the present invention the pre-treatment comprises:
an acidic pre-treatment; or
an acidic pre-treatment and an alkaline pre-treatment; or
an acidic pre-treatment and a hydrogen peroxide pre-treatment
an alkaline pre-treatment and an acidic pre-treatment and; or
an alkaline pre-treatment; or
an alkaline pre-treatment and a hydrogen peroxide pre-treatment; or
a hydrogen peroxide pre-treatment.

Preferably, the pre-treatment may involve at least the alkaline pre-treatment (pre-treatment (b)) in combination with the acidic pre-treatment (pre-treatment (a)).

The sequence of acidic pre-treatment (pre-treatment (a)); the alkaline pre-treatment (pre-treatment (b)); and/or the hydrogen peroxide pre-treatment (pre-treatment (c)) may be optional.

The alkaline pre-treatment (pre-treatment (b)) may be performed using a strong base. Strong bases may be bases which completely dissociate in water into the cation and OH— (hydroxide ion) and anion. In an embodiment of the present invention, hydroxides of the Group I (alkali metals) and Group II (alkaline earth) metals are considered strong bases.

In a further embodiment of the present invention the strong base may be selected from a hydroxide compound. Preferably, the strong base may be selected from the group consisting of NaOH (sodium hydroxide); LiOH (lithium hydroxide); KOH (potassium hydroxide); RbOH (rubidium hydroxide); CsOH (cesium hydroxide); Ca(OH)₂ (calcium hydroxide); Sr(OH)₂ (strontium hydroxide); and/or Ba(OH)₂ (barium hydroxide).

In one embodiment of the present invention, the concentration of the base used in the alkaline pre-treatment may be within the range of 5-25 wt %, such as in the range of 8-20 wt % (weight percent), e.g., in the range of 9-15 wt %, such as about 10 wt %.

The alkaline pre-treatment may preferably be performed at a temperature in the range of 20-95 degrees Celsius, such as in the range of 30-90 degrees Celsius, e.g., in the range of 40-85 degrees Celsius, such as in the range of 60-75 degrees Celsius, e.g., about 70 degrees Celsius.

The alkaline pre-treatment may preferably be performed for a period in the range of 5-60 minutes, such as for a period of 15-45 minutes, e.g., for about 30 minutes.

The acidic pre-treatment (pre-treatment (a)) may be performed using a strong acid. The strong acid may be selected from the group consisting of HCl (hydrochloric acid); H₂SO₄ (sulfuric acid); HNO₃ (nitric acid); HBr (hydrobromic acid); HClO₄ (perchloric acid); or HI (hydroiodic acid). Preferably, the strong acid is H₂SO₄ (sulfuric acid).

In an embodiment of the present invention the concentration of the acid used in the acidic pre-treatment may have a concentration in the range of 0.1-3M (moles per liter), such as in the range of 0.3-2.5M, e.g., in the range of 0.5-2.0M, such as in the range of 0.6-1.5M, e.g., in the range of 0.75-1.0M.

The acidic pre-treatment may preferably be performed at a temperature in the range of 20-95 degrees Celsius, such as in the range of 30-85 degrees Celsius, e.g., in the range of 40-75 degrees Celsius, preferably within the range of 50-65 degrees Celsius, e.g., about 60 degrees Celsius.

The acidic pre-treatment may preferably be performed for a period in the range of 5-60 minutes, such as for a period of 15-45 minutes, e.g., for about 30 minutes. Obviously, the pre-treatment may be performed for even longer time, but without any significantly improved effect.

The hydrogen peroxide pre-treatment (pre-treatment (c)) may be performed using a concentration of hydrogen peroxide in the range of 5-25 wt % (weight percent), such as in the range of 8-20 wt %; e.g., in the range of 9-15 wt %, such as about 10 wt %.

The hydrogen peroxide pre-treatment (pre-treatment (c)) may include a base, preferably a strong base, e.g., a strong base as mentioned herein. Preferably, the hydrogen peroxide solution may have a concentration of strong base in the range of 5-25 wt % (weight percent), such as in the range of 8-20 wt %, e.g., in the range of 9-15 wt %, such as about 10 wt %.

The hydrogen peroxide pre-treatment (pre-treatment (c)) may include a step of adjusting the pH-value of the hydrogen peroxide solution. Preferably, the pH-value of the hydrogen peroxide solution may be adjusted to a pH-value in the range of pH 9-14, such as in the range of pH 10-13; e.g., pH 12.

The hydrogen peroxide pre-treatment may preferably be performed at a temperature in the range of 20-95 degrees Celsius, such as in the range of 30-90 degrees Celsius, e.g., in the range of 40-85 degrees Celsius, such as in the range of 60-75 degrees Celsius, e.g., about 70 degrees Celsius.

The hydrogen peroxide pre-treatment may preferably be performed for a period in the range of 5-60 minutes, such as for a period of 15-45 minutes, e.g., for about 30 minutes. Obviously, the pre-treatment may be performed for even longer time, but without any significantly improved effect.

The acidic pre-treatment (pre-treatment (a)); the alkaline pre-treatment (pre-treatment (b)); and/or the hydrogen peroxide pre-treatment (pre-treatment (c)) may be supplemented with a chelating agent.

Preferably, the alkaline pre-treatment (pre-treatment (b)); and/or the hydrogen peroxide pre-treatment (pre-treatment (c)) may be supplemented with a chelating agent. Sodium carbonate has proven particularly efficient at dissolving silicate particles.

The chelating agent may during the pre-treatment, and/or during the decolourization in steps (ii) or (iii), scavenges metallic ions from the pigments used and ensuring solubility of the pigments and removing silicates (e.g., SiO₂) and metal-ions from the textile product.

In an embodiment of the present invention the concentration of the chelating agent supplemented may have a concentration in the range of 1-100 mg/l, such as in the range of 5-75 mg/l, e.g., in the range of 10-60 mg/l, such as in the range of 15-50 mg/l, e.g., in the range of 25-40 mg/l, such as about 35 mg/l.

In one or more embodiments, the pre-treatment step(s) are followed by a washing step before adding said first or second decolorizing agent during step (ii) or (iv).

In one or more embodiments, the second decolorizing agent in the second decolorization step (iv) are selected from dihydrolevoglucosenone (Cyrene), dimethyl sulfoxide (DMSO), methyl-sulfonyl-methane (DMSO₂), sulfolane, or a combination thereof. Preferably, the second decolorizing agent in the second decolorization step (iv) is dimethyl sulfoxide (DMSO). Preferably, the aprotic solvent has a boiling point above 180 degrees Celsius, such as within the range of 185-300 degrees Celsius.

In a further embodiment of the present invention the aprotic solvent comprises (consist essentially of) an organosulfur compound.

The organosulfur compound may preferably be selected from dimethyl sulfoxide (DMSO), methyl-sulfonyl-methane (DMSO₂), sulfolane, or a combination thereof.

In an embodiment of the present invention the solvent and the second decolorizing agent are the same.

Preferably the solvent used and/or the decolorizing agent used may be isolated and recircled. The isolation may be possible e.g., by evaporation, distillation, Membrane Cross flow filtration, OSN (organic solvent Nanofiltration), antisolvent precipitation, crystallization, or the like. Such techniques are generally known within the art.

In one or more embodiments, the second decolorization step (iv) is performed at a temperature within the range of 20-180 degrees Celsius, such as within the range of 30-175 degrees Celsius, e.g., within the range of 40-170 degrees Celsius, such as within the range of 50-165 degrees Celsius, e.g., within the range of 60-160 degrees Celsius, preferably within the range of 80-150 degrees Celsius, more preferably within the range of 100-140 degrees Celsius, e.g., at a temperature of about 140 degrees Celsius.

In one or more embodiments, the coloured textile product comprises fibres selected from cotton, polyester, cellulose fibres, and mixtures thereof. Preferably, the coloured textile product comprises fibres selected from cotton, and polyester.

In one or more embodiments, the coloured textile product comprises:
a) fibres selected from cotton, polyester, cellulose fibres, and mixtures thereof; and
b) fibres of elastane. In one or more embodiments, the elastane is removed during said process steps, thereby resulting in a solid fraction substantially free from elastane.

A second aspect relates to a solid fraction produced by the process according to the present invention.

In one or more embodiments, wherein when the textile product comprises a mixture of synthetic fibres and natural fibres, the process may further comprise the steps of:
(iv) adding a solvent to the decolorized textile product (the separated solid fraction),
(v) allowing the solvent to react with the decolorized textile product at a temperature between 170-200° C., thereby providing a solubilized fraction and an un-solubilized fraction;
(vi) separating the solubilized fraction (liquid fraction) from the un-solubilized fraction (solid fraction), thereby providing a solubilized fraction comprising the synthetic fibre, and an un-solubilized fraction comprising the natural fibre.

In one or more embodiments, the textile product comprises polyester fibres and cellulose fibres.

In an embodiment of the present invention, the synthetic fibre provided in step (vi) comprises (or consist essentially of) a polyester fibre.

In yet an embodiment of the present invention the natural fibre provided in step (vi) comprises (or consist essentially of) a cellulose fibre.

In an embodiment of the present invention, the un-solubilized fraction may be subjected to a washing process, preferably an aqueous washing process, preferably using pure water.

Following the washing process, the un-solubilized fraction may be dried and spun to a fibre product.

In one or more embodiments, the solvent is selected from an aprotic solvent, such as dihydrodihydrolevoglucosenone (Cyrene), dimethyl sulfoxide (DMSO), methyl-sulfonyl-methane (DMSO₂), sulfolane, or a combination thereof. Preferably, the aprotic solvent has a boiling point above 180 degrees Celsius, such as within the range of 185-300 degrees Celsius.

In a further embodiment of the present invention, the aprotic solvent comprises (consist essentially of) an organosulfur compound.

The organosulfur compound may preferably be selected from dimethyl sulfoxide (DMSO), methyl-sulfonyl-methane (DMSO₂), sulfolane, or a combination thereof.

Preferably the solvent used may be isolated and recircled. The isolation may be possible e.g., by evaporation, distillation, Membrane Cross flow filtration, OSN (organic solvent Nanofiltration), antisolvent precipitation, crystallization, or the like. Such techniques are generally known within the art.

In one or more embodiments, the process steps are performed in the same reactor.

The inventors of the present invention have surprisingly found that the process according to the present invention results in a high quality of the solid fraction comprising natural fibres with little degradation and at the same time with little dye left in the fibre.

The generally separated color-fractions may comprise dyes, dye residues, SiO₂, silicates, and metals-ions that were present in the textile product. Furthermore, the color-fraction may comprise soluble polymers from the textile product, such as polyether and/or a polyurethane. The polyurethane may be elastane.

After cooling of a color-fraction, e.g., to room temperature, the polyether and/or the polyurethane may be separated therefrom, e.g., by skimming or decanting, to form a second solid fraction. The second solid fraction may preferably consist essentially of a polyether and/or a polyurethane compound, except for minor impurities.

In one or more embodiments, a solvent may be added to the decolorized textile product to solubilize the decolorized textile product or parts hereof, thereby providing a solubilized fraction and an un-solubilized fraction. The solubilized fraction preferably comprises a second solid fraction. The un-solubilized fraction comprises a third solid fraction.

In a further embodiment of the present invention the solubilized fraction preferably consists essentially of a second solid fraction, except for a minor impurity of the first solid fraction and/or the third solid fraction.

In yet an embodiment of the present invention the un-solubilized fraction consists essentially of a third solid fraction, except for a minor impurity of the first solid fraction and/or the second solid fraction.

In the context of the present invention the term “a minor impurity” relates to a content of the solid fraction in question of at most 5 wt %, such as at most 4 wt %, e.g., at most 3 wt %, such as at most 2 wt %, e.g., at most 1 wt %, such as at most 0.75 wt %, e.g., at most 0.5 wt %, such as at most 0.1 wt %, e.g., at most 0.05 wt %.

In an embodiment of the present invention the second solid fraction comprises (or consist essentially of) a polyester compound and/or the third solid fraction comprises (or consist essentially of) a cellulose compound.

The polyester compound may be Polyethylene terephthalate (PET).

The decolorization performed in step (ii) may preferably be controlled (e.g., by adjusting time, temperature, and/or chemical(s)) to avoid or limit solubility of polyester (when present in the textile product).

In an embodiment of the present invention the solubilization (of the solubilized fraction) may be performed at a temperature in the range of 170-200° C., such as in the range of 180-190° C., e.g., about 185° C.

When solubilized, the solubilized fraction may be separated from the un-solubilized fraction.

The resulting solubilized fraction may be subjected to a crystallization process, providing a crystallized synthetic solid fraction.

In an embodiment of the present invention the synthetic solid fraction may, after being separated from the un-solubilized fraction, be crystallized be collected in a tank and cooled, e.g., to about room temperature, whereby the synthetic solid fraction may crystallize. Following the crystallization, the crystalized synthetic solid fraction may be separated by filtration or centrifugation. The resulting isolated crystalized synthetic solid fraction may optionally be dried, before being melted into a single piece of synthetic solid fraction.

The crystallized synthetic solid fraction may be collected as a particulate fraction and optionally dried to a powder fraction. Preferably, the crystallization process includes the presence of the solvent and a temperature below 170° C., such as below 160° C., e.g., below 140° C., such as below 120° C., e.g., below 100° C., such as below 75° C., e.g., below 50° C., such as below 35° C., e.g., below 25° C.

Thus, a preferred embodiment of the present invention relates to a solid fraction obtained from a textile product comprising a natural fibre having a degree of polymerization (DP) above 500, e.g., above 1000, such as above 1500, e.g., above 2000, such as above 2500, e.g., above 3000, such as above 3500, e.g., above 4000, such as above 4500 and/or having a whiteness of at least 50% measured by DIN53 145, preferably at least 60%, e.g., at least 70%, such as at least 80%, and more preferably at least 90%, such as at least 95%, e.g., at least 99%.

In an embodiment of the present invention 25 wt % or more of the natural fibre comprises a degree of polymerization (DP) above 500, e.g., above 1000, such as above 1500, e.g., above 2000, such as above 2500, e.g., above 3000, such as above 3500, e.g., above 4000, such as above 4500, such as 30 wt % or more, e.g., 40 wt % or more, such as 50 wt % or more, e.g., 60 wt % or more, such as 70 wt % or more, e.g., 80 wt % or more, such as 90 wt % or more, e.g., 95 wt % or more, such as 98 wt % or more.

In yet an embodiment of the present invention less than 25 wt % of the natural fibre comprises a degree of polymerization (DP) less than 500, such as less than 20 wt %, e.g., less than 15 wt %, such as less than 10 wt %, e.g., less than 5 wt %, such as less than 2 wt %, e.g., less than 1 wt %.

Preferably, the content of one or more synthetic fibres (or fractions hereof) in the solid fraction, the natural solid fraction, is less than 15 wt %, such as less than 10 wt %, e.g., less than 5 wt %, such as less than 2 wt %, e.g., less than 1 wt %, such as less than 0.5 wt %, e.g., less than 0.1 wt %, such as less than 0.05 wt %.

In yet an embodiment of the present invention:
25 wt % or more of the natural fibre comprises a degree of polymerization (DP) above 300, such as above 500, e.g., above 1000, such as above 1500, e.g., above 2000, such as above 2500, e.g., above 3000, such as above 3500, e.g., above 4000, such as above 4500, such as 30 wt % or more, e.g., 40 wt % or more, such as 50 wt % or more, e.g., 60 wt % or more, such as 70 wt % or more, e.g., 80 wt % or more, such as 90 wt % or more, e.g., 95 wt % or more, such as 98 wt % or more; and/or
less than 25 wt % of the natural fibre comprises a degree of polymerization (DP) less than 300, such as less than 20 wt %, e.g., less than 15 wt %, such as less than 10 wt %, e.g., less than 5 wt %, such as less than 2 wt %, e.g., less than 1 wt %; and/or
the content of one or more synthetic fibres (or fractions hereof) in the solid fraction is less than 15 wt %, such as less than 10 wt %, e.g., less than 5 wt %, such as less than 2 wt %, e.g., less than 1 wt %, such as less than 0.5 wt %, e.g., less than 0.1 wt %, such as less than 0.05 wt %.

Preferably, the dye content of the solid fraction is invisible to the human eye.

It should be noted that embodiments and features described in the context of one of the aspects of the present invention also apply to the other aspects of the invention.

### Examples

1) In a first example, mixed textile waste (black, grey, and blue mixtures) was mechanically shredded into 6-8 mm pieces. The content of the fabric was known to be a mix of polyester and cotton with an unknown fraction of other textile contents, such as elastane, nylon thread, etc. The textiles were a mix of several postconsumer textiles (20-23 different types) with a polyester content of 30-60%. The cotton content constituted 40-70% and the dyes are assumed to be a mix of reactive, direct (azo), and disperse dyes.

Four samples were treated in varying concentrations of sodium dithionite (DT)+sodium hydroxide (NaOH), as listed in the table below. The alkaline conditions were present to stabilize the sodium dithionite in solution. A treatment with only aqueous sodium hydroxide has been tried with no noticeable effect on decolorization of the textile.

| | | % Whiteness | Decolorization 1 | | | |
|---|---|---|---|---|---|---|
| Sam- | wt % | before | | T | t | % |
| ple | textile | treatment | Chemicals | [° C.] | [min] | Whiteness |
| 1 | 2 | 4.6* | 10 g/L NaOH + | 30 | 30 | 6.26 |
| | | | 10 g/L DT | | | |
| 2 | 2 | | 10 g/L NaOH + | 85 | 30 | 11.3 |
| | | | 10 g/L DT | | | |
| 3 | 2 | | 40 g/L NaOH + | 30 | 30 | 6.21 |
| | | | 30 g/L DT | | | |
| 4 | 2 | | 40 g/L NaOH + | 85 | 30 | 15.6 |
| | | | 30 g/L DT | | | |

Little effect was observed at a temperature of 30 degrees Celsius, while an increased temperature to 85 degrees Celsius gave better but still poor results.
2) In a second example, the four samples from the first example and a fifth untreated sample (equal to the untreated samples 1-4) were treated in DMSO at 140 degrees Celsius, as listed in the table below.

| | | % Whiteness | Decolorization 2 | | | |
|---|---|---|---|---|---|---|
| | wt % | before | | T | t | % |
| Sample | textile | treatment | Chemicals | [° C.] | [min] | Whiteness |
| 1 | 2 | 4.6* | DMSO | 140 | 60 | 15.1 |
| 2 | 2 | | DMSO | 140 | 60 | 32.1 |
| 3 | 2 | | DMSO | 140 | 60 | 12.0 |
| 4 | 2 | | DMSO | 140 | 60 | 49.9 |
| 5 | 2 | | DMSO | 140 | 60 | 5.60 |

As can be seen from sample 5, the pure DMSO treatment did not result in any noticeable decolorization (i.e., increase in whiteness) of the textile. However, all samples 1-4 showed a significantly better decolorization when subsequently treated with DSMO. Experiments with the same an aqueous sodium hydroxide treatment, followed by a DMSO treatment did show a little but unsatisfactory improvement.
3) In a third example, two different textile samples were used. The first sample was of 100% cotton colored with reactive dyes. The second sample was of 100% polyester colored with disperse dyes.

Both samples (1 gram) were first added to an aqueous solution (50 milliliters) of sodium dithionite (30 g/liter of water) and sodium hydroxide (40 g/liter of water), which was heated to 85 degrees Celsius for 30 minutes, using a magnetic stirrer with heater (RSM-03-4KH from Phönix Instrument).

Afterwards, to remove silicates and metals, both of the samples were treated in two additional steps, first with an aqueous 10 wt % sodium hydroxide (30 minutes at 70 degrees Celsius), and secondly with an aqueous 1M sulfuric acid solution (30 minutes at 60 degrees Celsius), before being rinsed in demineralized water and dried overnight.

Next, the samples were treated in DMSO for 60 minutes at 140 degrees Celsius while being stirred.

Finally, the samples were rinsed in demineralized water and dried overnight.

A negative control sample was made for both textiles, where the same procedure as above was followed, only skipping the sodium dithionite-sodium hydroxide step.

In general, whiteness measurements were made using a PCE-WSB 1 device, purchased from PCE-instruments.com, which complies with ISO 2471-77 (Paper and board-Determination of opacity (paper backing)—Diffuse reflectance method).

For further comparison, two samples were made for both textiles and treated, respectively, with DMSO for 60 minutes at 140 degrees Celsius and 170 degrees Celsius. The polyester sample disintegrated at 170 degrees Celsius, why there are no % whiteness data on this treatment.

The results are summarized in the table below, where results are given as the mean of a triple measurement (individual measurements in parentheses).

| Sample | 1. cotton | 2. polyester |
|---|---|---|
| % Whiteness untreated | (14.0, 14.5, 14.3) | (51.8, 51.4, 50.4) |
| | 14.3 | 51.2 |
| % Whiteness after | (70.6, 71.2, 70.3) | (66.3, 66.2, 65.5) |
| treatment | 70.7 | 66.0 |
| Negative control | (36.4, 37.2, 36.9) | (43.9, 43.8, 44.3) |
| | 36.8 | 44.0 |
| DMSO (140° C.) | (15.2, 14.6, 14.8) | (55.3, 55.6, 55.4) |
| | 14.9 | 55.4 |
| DMSO (170° C.) | (14.8, 15.4, 15.4) | N/A |
| | 15.2 | |

For the cotton samples, the % Whiteness was increased from 14.3 to 70.7% Whiteness, compared to the smaller increase in the negative control sample of 14.3 to 36.8% Whiteness.

For the polyester samples, the textile material initially had a relatively large % Whiteness of 51.2 and a slight reduction in % Whiteness was seen with the negative control sample. The samples pre-treated with sodium dithionite-sodium hydroxide showed an increase to 66.0% Whiteness. The sole treatment with DMSO did not have any noticeable effect on decolorization.

1. A process for providing at least one solid fraction from a textile product comprising a natural fiber, a synthetic fiber, or both a natural fiber and a synthetic fiber, the process comprising the steps of:
(i) providing the textile product,
(ii) performing a first decolorization step of adding a liquid solution of a first decolorizing agent in water to the textile product, thereby providing a first decolorized textile product,
(iii) separating the first decolorized textile product from a color-fraction,
(iv) performing a second decolorization step of adding a second decolorizing agent comprising an aprotic solvent to the textile product, thereby providing a second decolorized textile product, and
(v) separating the second decolorized textile product from a color-fraction, thereby providing the at least one solidfraction, wherein
the first decolorizing agent in the first decolorization step (ii) is an aqueous solution of a water-soluble salt of dithionous acid.

2. The process according to claim 1, wherein the second decolorizing agent in the second decolorization step (iv) is selected from dihydrolevoglucosenone (Cyrene), dimethyl sulfoxide (DMSO), methyl-sulfonyl-methane (DMSO2), sulfolane, or a combination thereof.

3. The process according to claim 1, wherein the second decolorizing agent in the second decolorization step (iv) is dimethyl sulfoxide (DMSO).

4. The process according to claim 1, wherein the water-soluble salt of dithionous acid is provided in an aqueous alkaline solution.

5. The process according to claim 1, wherein said textile product is subjected to a pre-treatment step before the first decolorization step (ii), wherein said pre-treatment step comprises one or more of:
an acidic treatment;
an alkaline treatment; and
a hydrogen peroxide treatment.

6. The process according to claim 5, wherein said pre-treatment step is followed by a washing step before adding said first decolorizing agent during step (ii).

7. The process according to claim 1, wherein said textile product is subjected to a pre-treatment step before the second decolorization step (iv), wherein said pre-treatment step comprises one or more of:
an acidic treatment;
an alkaline treatment; and
a hydrogen peroxide treatment.

8. The process according to claim 7, wherein said pre-treatment step is followed by a washing step before adding said second decolorizing agent during step (iv).

9. The process according to claim 1, wherein the first decolorization step (ii) is performed at a temperature within a range of 30-100 degrees Celsius, preferably within a range of 50-95 degrees Celsius, more preferably within a range of 70-90 degrees Celsius.

10. The process according to claim 1, wherein the second decolorization step (iv) is performed at a temperature within a range of 20-180 degrees Celsius, preferably within a range of 80-160 degrees Celsius, more preferably within the range of 100-140 degrees Celsius.

11. The process according to claim 1, wherein the textile product comprises fibres fibers selected from cotton, polyester, cellulose fibers, and mixtures thereof.

12. The process according to claim 1, wherein the textile product comprises:
a) fibers selected from cotton, polyester, cellulose fibres, and mixtures thereof; and
b) fibers of elastane.

13. The process according to claim 12, wherein the elastane is removed during said process steps, thereby resulting in a solid fraction substantially free from elastane.

14. A solid fraction produced by the process according to claim 1.
